(19) United States
(12) Patent Application Publication
(10) Pub. No.: US 2016/0132913 A1
(43) Pub. Date: May 12, 2016

(54) Multivariate Canonical Data Model for Tagging Customer Base of Energy Utility Enterprise

(71) Applicant: IGATE Global Solutions Ltd., Navi Mumbai (IN)

(72) Inventors: Jasjeet Singh Hanjrah, Navi Mumbai (IN); Bipin Patwardhan, Navi Mumbai (IN); Sanghamitra Mitra, Navi Mumbai (IN); Nilendra Chaudhari, Navi Mumbai (IN)

(21) Appl. No.: 14/683,104

(22) Filed: Apr. 9, 2015

(30) Foreign Application Priority Data
Nov. 11, 2014 (IN) 3546/MUM/2014

(51) Int. Cl. G06Q 30/02

(52) U.S. Cl. CPC G06Q 30/0204

(57) ABSTRACT

A system and method contact a customer of an energy utility to solicit participation in an energy efficiency, sustainability, or reliability program. The system receives data pertaining to each customer, the data for each customer having a plurality of attributes pertaining to a customer descriptive characteristic, communications history, energy usage, or attitude. The data are normalized to a canonical form, and populated in a multivariate data model. Data in the model is clustered using a multivariate algorithm. Each cluster is assigned a utility customer segment, such as “Concerned Green” or “DIY”, that reflects the prevalent attributes. For each segment, the system determines a prospect subset of the customers most likely to participate in an offering pertaining to that segment according to a likelihood threshold. Finally, a prospect customer is contacted with an offering that may be customized according to the assigned customer segment.

### CROSS REFERENCE TO RELATED APPLICATION

This application claims the benefit of Indian Application No. 3546/MUM/2014, filed Nov. 11, 2014, the contents of which are incorporated herein by reference in their entirety.

### FIELD OF THE INVENTION

The invention generally relates to managing utility information and, more particularly, the invention relates to enabling segmenting of utility user information.

### BACKGROUND OF THE INVENTION

Energy sustainability and grid reliability is of paramount importance to utilities. Utilities undesirably have difficulty achieving these goals without active participation of their consumers. However, utilities are struggling to find out their “best bet customers” who would participate in key programs, and hence help to achieve these goals. Their struggles are caused in large part by the number of utility customers, the fact that each customer's relationship to energy is different, and the relatively high cost of contacting all customers.

### SUMMARY OF VARIOUS EMBODIMENTS

Illustrative system and method embodiments facilitate contacting a customer of an energy utility to solicit participation in an energy efficiency, sustainability, or reliability program. The system receives data pertaining to each customer, the data for each customer having a plurality of attributes pertaining to a customer descriptive characteristic, communications history, energy usage, or attitude. The data are normalized to a canonical form, and populated in a multivariate data model. Data in the model is clustered using a multivariate algorithm. Each cluster is assigned a utility customer segment, such as “Concerned Green” or “DIY”, that reflects the prevalent attributes. For each segment, the system determines a prospect subset of the customers most likely to participate in an offering pertaining to that segment according to a likelihood threshold. Finally, a prospect customer is contacted with an offering that may be customized according to the assigned customer segment.

Illustrative embodiments can tag the consumers of an energy utility into categories such as “Concerned Greens,” “Young Age,” “Do It Yourself and Save,” “Traditional,” “Heavy Spenders,” etc. For example, people who are willing to pay extra for “green energy” may be grouped together so that suitable plans and offerings can be created for them and/or extended to them. Though tagged to categories, it should be noted that most or all consumers, regardless of their category, typically have similar set of attributes, preferences, and needs.

Thus, a first embodiment of the invention is a method of contacting a customer of an energy utility enterprise to solicit the customer's participation in a program to improve energy efficiency, sustainability, or reliability. The method includes in a first computer process, receiving data pertaining to each customer in a plurality of utility enterprise customers, wherein the data for each customer include a plurality of attributes having values, wherein each attribute pertains to a (a) customer descriptive characteristic, (b) customer communications history with the utility enterprise, (c) customer energy usage behavior, or (d) customer attitude about energy, and wherein each value is normalized or non-normalized. Next, the method includes in a second computer process, populating a data model with the received data, wherein populating the data model includes transforming all non-normalized attribute values into normalized, numerical values. Then in a third computer process, the method includes producing a plurality of data clusters by applying multivariate clustering to the populated data model, each data cluster including a plurality of data points, each such data point being associated with an individual utility customer. In a fourth computer process, the method requires assigning to each cluster in the plurality of data clusters a segment in a plurality of utility customer segments, each such segment indicating, for each data point in the data cluster, either (a) a program that could improve energy efficiency, sustainability, or reliability for the associated individual utility customer, or (b) that no such program is appropriate. Subsequently, in a fifth computer process, the method calls for determining, for each segment indicating a program, a prospect subset of the assigned customers, the prospect subset including all customers that are most likely to participate in the indicated program according to a likelihood threshold. Finally, for at least one given program, the method includes contacting a customer in the prospect subset of the given segment to solicit the customer's participation in the indicated program.

Various modifications on the basic method are contemplated. At least one received descriptive attribute may be: customer name, age, gender, location, usage category, employment status, annual income, or whether the customer uses a smart meter, a photovoltaic (PV) system, the Internet or a home area network (HAN), or an electric vehicle (EV). At least one received communications attribute may be: a social media identifier, a positive or negative nature of public communications about the energy utility enterprise, a preferred mode of contact, a resolution status of prior issues with the energy utility enterprise, a positive or negative nature of feedback directed to the energy utility enterprise, or a positive or negative response by the customer to a prior contact. At least one received energy usage behavior attribute may be: an average bill amount, an individual bill amount, an on-time or late nature of a prior bill payment, an average monthly energy demand, a maximum monthly energy demand, a maximum instantaneous energy demand, a parameter of an interconnection tariff, an amount of net metered energy, or an amount of excess energy generated by the customer that is purchased by the energy utility enterprise. Processing the plurality of data clusters may include applying one or more of: k-means clustering, fuzzy k-means clustering, Dirichlet clustering, hierarchical clustering, or canopy clustering.

The method may further include computing a graphical visualization of the populated data model comprising one data point for each utility customer, wherein the visualization distinctively shows the cluster into which the third computer process placed each data point; and displaying on a computer display the visualization and a selection tool that permits selection by an individual of one or more displayed data points. Determining the prospect subset may include receiving from the selection tool a selection of a plurality of displayed data points; and determining the prospect subset to be the customers associated with the selected data points. The method may also include receiving from the selection tool a selection of a single displayed data point; and displaying on the computer display a graphical view of the received attributes that pertain to the utility customer associated with the selected data point.

Contacting the customer may include contacting using: email, telephone, SMS, MMS, or a smartphone app. Contacting also may include customizing a parameter of the given program as a function of the plurality of attributes for the customer. The method may also include creating a new utility customer segment when the plurality of data clusters produced in the third computer process outnumber the plurality of utility customer segments.

A second embodiment of the invention is a system for contacting a customer of an energy utility enterprise to solicit the customer's participation in a program to improve energy efficiency, sustainability, or reliability. The system includes a data store, a data exchange system, a data preprocessor, a clustering processor, a segment processor, a customer selection processor, and a contact processor. The data exchange system is coupled to the customer via a data communication network. The data exchange system is configured to receive data pertaining to each customer in a plurality of utility enterprise customers, wherein the data for each customer include a plurality of attributes having values, wherein each attribute pertains to a (a) customer descriptive characteristic, (b) customer communications history with the utility enterprise, (c) customer energy usage behavior, or (d) customer attitude about energy, and wherein each value is normalized or non-normalized.

The data preprocessor is configured to store in the data store a data model populated with the received data, wherein storing the data model includes transforming all non-normalized attribute values into normalized, numerical values. The clustering processor is configured to produce a plurality of data clusters by applying multivariate clustering to the populated data model, each data cluster including a plurality of data points, each such data point being associated with an individual utility customer. The segment processor is configured to assign to each cluster in the plurality of data clusters a segment in a plurality of utility customer segments, each such segment indicating, for each data point in the data cluster, either (a) a program that could improve energy efficiency, sustainability, or reliability for the associated individual utility customer, or (b) that no such program is appropriate. The customer selection processor is configured to determine, for each segment indicating a program, a prospect subset of the assigned customers, the prospect subset including all customers that are most likely to participate in the indicated program according to a likelihood threshold. The contact processor is configured to contact a customer in the prospect subset for at least one given program, to solicit the customer's participation in the indicated program.

The system embodiment may be modified to implement the methods discussed above. In particular, the clustering processor may be further configured to apply one or more of: k-means clustering, fuzzy k-means clustering, Dirichlet clustering, hierarchical clustering, or canopy clustering. The customer selection processor may further have a computer display for displaying (a) a graphical visualization of the populated data model comprising one data point for each utility customer, wherein the visualization distinctively shows the cluster into which the third computer process placed each data point, and (b) a selection tool that permits selection by an individual of one or more displayed data points. The customer selection processor may be further configured to receive from the selection tool a selection of a plurality of displayed data points; and determine the prospect subset to be the customers associated with the selected data points. The customer selection processor and the contact processor may comprise a single device, and the contact processor may be further configured to receive from the selection tool a selection of a single displayed data point; and display on the computer display a graphical view of the received attributes that pertain to the utility customer associated with the selected data point. The contact processor may be further configured to contact the customer using: email, telephone, SMS, MMS, or a smartphone app. Finally, contacting the customer in the prospect subset of the given program may comprise the contact processor customizing a parameter of the given program as a function of the plurality of attributes for the customer.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 is a flowchart providing a method of contacting high-likelihood energy utility customers to solicit the customer's participation in a program to improve energy efficiency, sustainability, or reliability according to an embodiment of the invention.

FIG. 2 is a schematic view of an exemplary simplified power generation, transmission, and distribution system in which an embodiment may be used.

FIG. 3 shows a schematic representation of a customer contacting system according to an embodiment of the invention.

### DESCRIPTION OF ILLUSTRATIVE EMBODIMENTS

Illustrative system and method embodiments facilitate contacting a customer of an energy utility to solicit participation in an energy efficiency, sustainability, or reliability program. The system receives data pertaining to each customer, the data for each customer having a plurality of attributes pertaining to a customer descriptive characteristic, communications history, energy usage, or attitude. The data are normalized to a canonical form, and populated in a multivariate data model. Data in the model is clustered using a multivariate algorithm. Each cluster is assigned a utility customer segment, such as “Concerned Green” or “DIY”, that reflects the prevalent attributes. For each segment, the system determines a prospect subset of the customers most likely to participate in an offering pertaining to that segment according to a likelihood threshold. Finally, a prospect customer is contacted with an offering that may be customized according to the assigned customer segment.

Illustrative methods and systems create a data model for consumer tagging for an energy utility enterprise—i.e., the systems identify certain customers as having a prescribed attribute through this tagging process. More specifically, utility enterprises often have programs to increase the outreach of their services, as well as ways and means to reduce energy usage. To that end, illustrative embodiments use various attributes to tag or segment their customers (also referred to as “users”) to find a combination of attributes that meets the utility's purpose. Using tagging, utility enterprises can, for example, find “energy conscious” or “wealthy” consumers (among other types of customers) who can be contacted for special programs and offers that may appeal to such users.

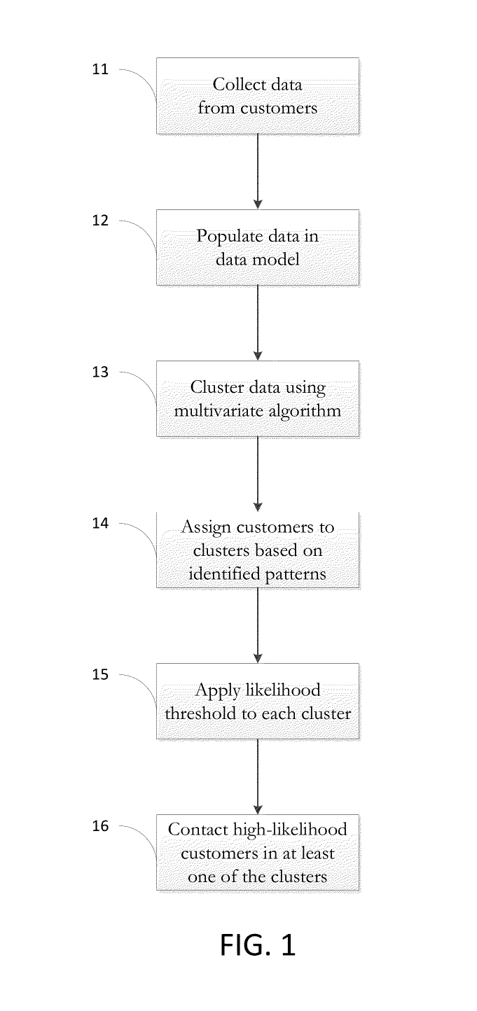

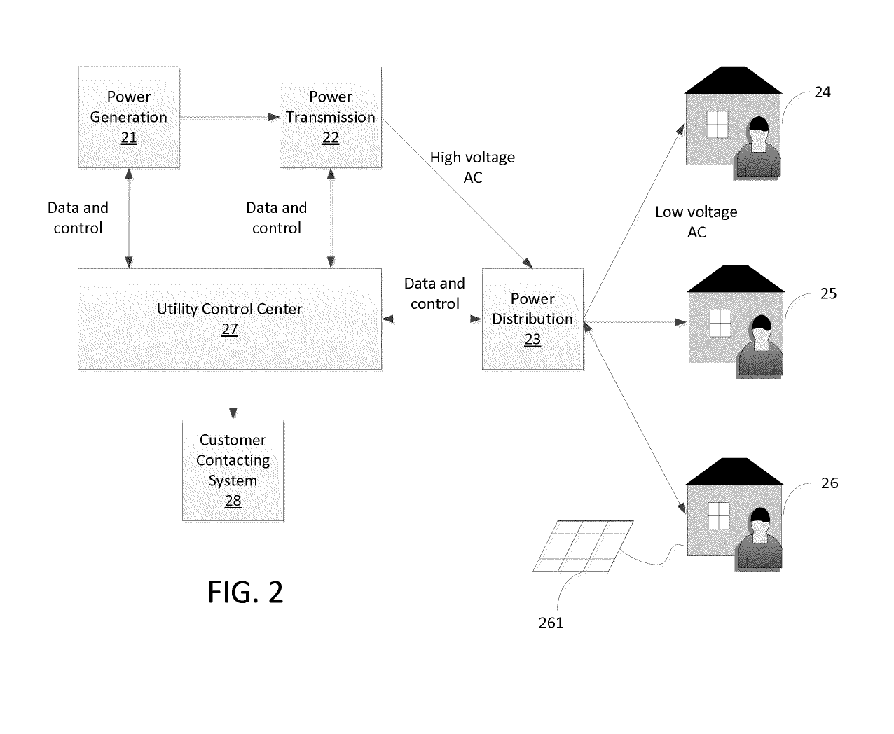

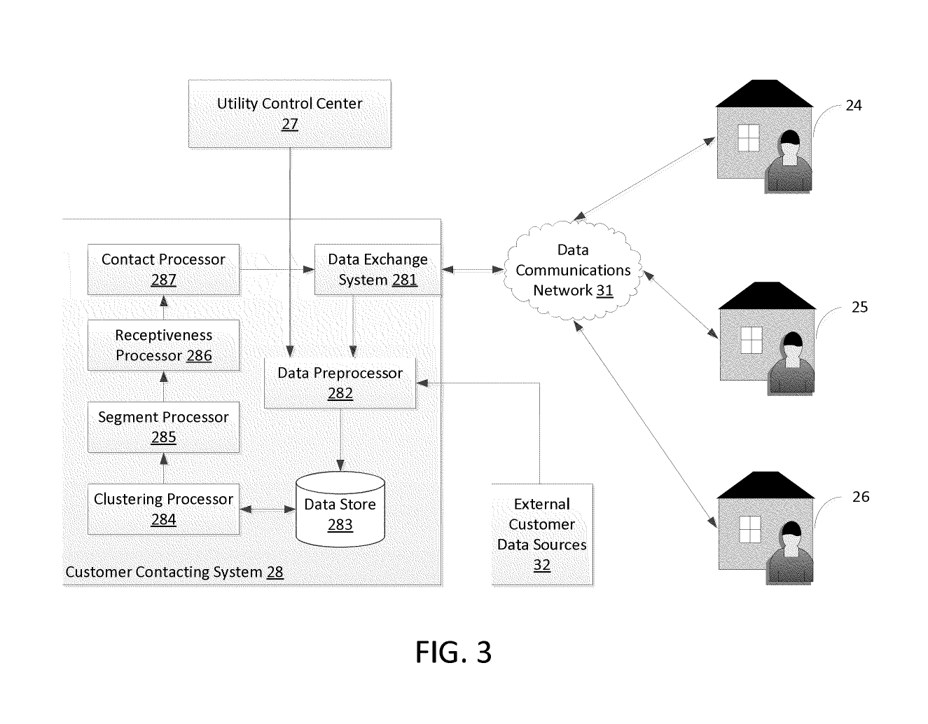

FIG. 1 is a flowchart providing a method of contacting high-likelihood energy utility customers to solicit the customer's participation in a program to improve energy efficiency, sustainability, or reliability according to an embodiment of the invention. In a first computer process 11, the utility collects attribute data pertaining to each of a number of customers. In a preferred embodiment, the utility uses a computer system (described in more detail in connection with FIGS. 2 and 3) to collect data about all of its customers, but fewer customers may be selected in any given embodiment for a variety of business reasons.

Given that illustrative embodiments are specific to energy utility enterprises, the method defines a meta-model based on the customer's attributes that relate specifically to her relationship to energy usage, thereby ensuring accurate groupings of customers by program. This model may be empirically developed and tested to confirm accuracy. Customer attributes may describe the customer's personal or demographic characteristics, her communications history with the energy utility, her energy usage behavior, or her general or specific attitude towards energy or particular modes of energy production or use.

Modeled customer-descriptive attributes may include the customer's name, age, gender, location, usage category (i.e., whether residential, commercial, or industrial), employment status, annual income, or whether the customer uses a smart meter, a photovoltaic (PV) system, the Internet or a home area network (HAN), or an electric vehicle (EV). Modeled communications-descriptive attributes may include a social media identifier, a positive or negative nature of public communications about the energy utility enterprise, a preferred mode of contact, a resolution status of prior issues with the energy utility enterprise, a positive or negative nature of feedback directed to the energy utility enterprise, a positive or negative response by the customer to a prior contact, and any results from prior attempts to contact the customer about participating in energy-saving programs. Modeled usage-descriptive attributes may include an average bill amount, an individual bill amount, an on-time or late nature of a prior bill payment, an average monthly energy demand, a maximum monthly energy demand, a maximum instantaneous energy demand, a parameter of an interconnection tariff, an amount of net metered energy, or an amount of excess energy generated by the customer that is purchased by the energy utility enterprise. Modeled attitude-descriptive attributes include customer views, opinions, and concerns about various modes of energy generation and usage (such as “green” or “renewable” energy), the customer's individual energy needs, the customer's individual energy preferences, and how strongly the customer feels about any of these. It should be appreciated that other attributes may be used in a multivariate customer model without departing from the scope of the invention.

It should be noted that the data model can be extended to include more attributes and/or data sets as needed. Moreover, the user attributes preferably are collected from multiple data sources (e.g., different Internet sites).

As might be understood from the above description of user attributes, not all input data values are necessarily numerical. Moreover, not all input data have the same range. Therefore, in a second computer process 12, the method populates data in the data model by converting non-numerical attributes into numerical attributes and applying normalization rules. At the conclusion of this process 12, the multivariate data are stored in a canonical form, thereby avoiding unnecessary bias in the clustering process described below. If data is retrieved from multiple systems and in multiple formats, the process 12 also automatically converts the raw data into an acceptable data format. The process 12 also optionally permits selection of a certain subset of features to model, and to reduce the features modeled to permit better clustering of data.

As an illustration of the conversion and weighting principles, the range of the values of the attributes, such as income or consumption, may be much broader than other attributes, such as gender or other Boolean attributes typically having values 0 or 1. To reduce the effect of such higher values on the ability to cluster users, illustrative embodiments apply an attribute normalization rule so that the range of values is reduced to the same range (e.g., 0 to 3).

A sample model for normalization and weighting is presented in the table below. It should be noted that the table is meant for illustrative purpose only and does not cover all possibilities.

| Parameter | Value(s) | Normalization |
|---|---|---|
| Age | Years | As is, not normalized |
| Area Type | Hot/Cold/Mild | Hot - 65. Cold - 3. |
| | | Mild - 22. |
| Type of Customer | Residential/Com- | Residential - 125. |
| | mercial/Industrial | Commercial - 600. |
| | | Industrial - 1000. |
| Average Bill | $ (dollars) | As is, not normalized |
| Amount | | |
| Preferred Bill | Paper/Electronic | Paper - 1. Electronic - 2. |
| Maximum Demand | KWH | As is, not normalized |
| Demand-Response | Yes/No | Yes - 1; No - 0. |
| Program Subscriber | | |
| Net Metering | Yes/No | Yes - 1; No - 0. |
| Photovoltaic Panel | Yes/No | Yes - 1; No - 0. |
| Electric Vehicle | Yes/No | Yes - 1; No - 0. |
| (EV) Ownership | | |

Assigning correct weights to each attribute enables illustrative embodiments to appropriately cluster the utility user information, as described in more detail below. As the algorithm computes the groupings based on similarity among the customers, to derive a correct similarity index, specific numeric values may be assigned to denote the correct representation. For example, the area type attribute may have the alphabetically based original values of “Hot”, “Mild” and “Cold.” Instead of assigning random numeric code like 1, 2, and 3, the system may assign the average temperature for each region to provide an appropriate representation of this attribute while calculating the similarity.

After the raw data have been converted, the system generates the multivariate canonical data model, which classifies the “similar sets of consumers” of the utility enterprise. This is the purpose of computer process 13, which clusters the data in the data model using a multivariate algorithm. The algorithm may use clustering techniques including, for example, one or more of k-means clustering, fuzzy k-means clustering, Dirichlet clustering, hierarchical clustering, or canopy clustering.

Given a multivariate data set, the goal of k-means clustering is to identify a number (called “k”) of different clusters within the data. These clusters are identified by “mean points” that each represent the center of the cluster. Each data point in the data set is associated with one such mean, so that a value of a function of the data and the means is minimized. For example, the function may be the sum of the squared distances between each data point and its associated mean; other such minimization functions are known in the art.

The clustering process is iterative. A selection of initial means is made at random or using a heuristic, and at each step a new set of means is computed from the old set of means, where the new set has a better (i.e. smaller) function value. In other words, each iteration of the process generates a new set of means, while the data in the data set remain unchanged. The new mean for each cluster is calculated as the average value (in the multidimensional data space) of the data points previously assigned to that cluster. As this calculation generally moves the location of each (interim) mean, it can change the assignment of data points to clusters, as some (fixed) data points become closer to different (moved, interim) means under function minimization. Therefore, the process continues iteratively until the set of means is stationary.

Fuzzy k-means clustering is a variant of this algorithm where each data point has a “degree” of being assigned to a cluster. In fuzzy k-means clustering, points are assigned a degree based on their distance from the mean. Points farther from the (interim) mean point are “in” the cluster to a lesser degree than those close to that mean point. Each iteration of the algorithm moves each mean based on the locations and weights of all data points, not just those closest to it.

Assuming that each datum in the data set is assigned to one of exactly k possible clusters, with either a multinomial distribution (each assignment has the same probability) or a categorical distribution (each assignment has a separate probability), one may model the set of means itself using a Dirichlet distribution. The use of the Dirichlet distribution in the clustering algorithm leverages the fact that it is a conjugate prior distribution for the multinomial and categorical distributions. That is, if the final distribution is assumed to be multinomial or categorical, then starting with a Dirichlet distribution will produce another Dirichlet distribution after each iteration. This simplifies performing the clustering calculations at each step.

For some embodiments of the invention, the number k is known in advance. Thus, if an electric or gas utility is considering to start a single energy efficiency program, it may take the value of k to be two: either customers will be interested in the program or they will not, and they should be clustered accordingly. However, if the utility is considering a number of different programs and the number to be actually implemented is not known in advance, the above algorithms have the disadvantage that they cannot determine the number k. In this case, a hierarchical clustering algorithm may be used.

Hierarchical clustering builds a hierarchy of clusters from an input data set according to a “bottom up” or a “top down” approach. In the “bottom up” approach, each data point in the multivariate space is treated initially as its own cluster, and there is an algorithm for merging pairs of clusters. In the “top down” approach, all data are considered to be in a single, initial cluster, and there is a corresponding iterative algorithm for splitting clusters recursively. For example, in the bottom up approach, one can form a new cluster by merging closest neighbors, forming a new cluster having a “location” at the mean, or average, of the two previous clusters. Keeping track of the merges forms a hierarchy or tree of clustering decisions that can be “trimmed” at a given position to provide any number of output clusters.

An advantage of hierarchical clustering is that it can indicate that the data contain more clusters than the number of existing service offerings, thereby suggesting to the utility enterprise that it should create new programs to reach additional customers. In particular, the new programs can be tailored to appeal to customers having the attributes that best define the newly-discovered clusters.

A disadvantage of hierarchical clustering is that it is often computationally complex. For example, “bottom up” clustering can take a time on the order of the third power of the input data size, while “top down” clustering can take a time exponential in the input data size. To reduce the computational time to perform hierarchical clustering (or even k-means or Dirichlet clustering), the process 13 may use canopy clustering prior to performing the other clustering algorithm(s).

Canopy clustering is a method to form “canopy” clusters in a data set quickly, at the expense of high accuracy. It is therefore useful to obtain initial mean points for use in the other algorithms. The canopy clustering algorithm iteratively takes a random point in the data set, assigns all other points within a “loose” or far distance to be in a “canopy” with the selected point, and removes from further consideration a subset of these points that are within a “tight” or closer distance from the selected point. Not all points in the canopy for a given starting data point are removed from further consideration, so a given data point may be in multiple canopies. Therefore, once canopy clustering is finished, a subsequent clustering algorithm (e.g. k-means, fuzzy k-means, Dirichlet, or hierarchical) may be used by the process 13 to determine the final clusters.

Once the data have been clustered, in a further computer process 14 the method assigns tags or customer segments to each cluster. Each segment represents an energy program that the utility enterprise is considering offering to its customers. Preferably, each cluster contains a similar set of people with closely aligned attributes (that is, closely aligned needs and preferences) that would benefit from a particular program. Accordingly, based on the tagging and segmentation generated by the system, the utility enterprise can identify the best programs to implement based on these common attributes and preferences, and approach the right set of consumers for each new or existing program. The attributes are specific and carefully selected to provide appropriate customer segmentation, therefore providing appropriate representation of the consumption patterns of the customers. The appropriate set of attributes enables derivation of the user segments suitable for the utility industry.

When properly grouped into particular segments, each of the users in a particular segment preferably has common attributes. For instance, one cluster may be defined as “Concerned Greens.” In that case, specific attributes of that group reflect the “green habits” of its users. People who have “Electric Vehicles” and “Solar Panels” in their daily lives thus may have shown highest probability to become part of “Concerned Greens” category. As another example, users with smart metering data may be included as part of the “DIY” (do-it-yourself) or “Easy Street” category. Consumers in the DIY category may have shown lesser than average bills for similar size or similar number of occupants than their counterparts, while the opposite may be the case for “Easy Street” category consumers.

The assignment made by the process 14 may be based on various heuristics, such as an observation that certain customer attributes are more highly predictive of placing the customer in the given cluster. The assignment also may be based on other techniques, such as application of pre-defined business rules, or based on further machine learning applied to characterize the data in each cluster separately. In this way, the utility therefore determines segments for their some or all of the customers they serve.

Once the users have been segmented and corresponding programs identified, in computer process 15 the method applies a likelihood threshold to each segment to produce a subset of customers who are good prospects to contact about the respective programs. Individual customers may be determined, for example, by taking those whose data points lie closest to the corresponding cluster mean—that is, the customers that are most strongly centered in the identified cluster. However, due to the expense in contacting customers, only a certain number of these identified customers are suitable for making contact. Thus, an adoption “likelihood threshold” number to contact is determined by various business rules. The number of contacts may be determined for the marketing campaign as a whole, or it may specified for each program.

Finally, in process 16 the energy utility contacts the high-likelihood prospects in at least one of the segments. In process 16, the utility enterprise can customize its offerings based on the tagging or segmenting generated by the system in process 14. Thus, the fact that a particular prospect was very centrally placed in her corresponding cluster could indicate that the person contacting the prospect should focus on emphasizing how the particular features of the given program would benefit the prospect. However, if a prospect is farther away from the cluster center, the person making contact may be advised to spend more time discussing the relative merits of various other programs offered by the utility. In particular, if the prospect's data point is located away from the mean for the given segment in the general direction of the mean of another cluster, the program indicated by the segment into which that other cluster was placed may be identified for use by process 16. Contact may be made using conventional means, such as email, telephone, SMS, MMS, or a smartphone app.

The processes 15 and 16 may be performed with the assistance of a graphical user interface. In particular, process 15 may computer a graphical visualization of the populated data model having one data point for each utility customer. Such a graphical visualization may be rendered on a computer display in two or more dimensions using conventional techniques. In a preferred embodiment, the visualization distinctively shows the cluster into which the process 13 placed each data point. Such distinctive display may be, for example, by coloring the data points of each cluster a given color, with different clusters having different colors.

Using such a graphical user interface, an individual working for the utility may determine a likelihood threshold using a selection tool, such as a mouse or other pointing device, that permits selection of one or more displayed data points. In particular, a system embodiment may receive a selection of a plurality of displayed data points and determine the prospect subset as the customers associated with the selected data points. In this way, the system does not need to determine the likelihood threshold number using an automatic heuristic, simplifying implementation of the embodiment. Such manual intervention advantageously permits customizable determination of the number of customers to contact for each contact campaign. Additionally, such a graphical user interface may also permit selection of a single displayed data point in order to display a graphical view of the attributes that pertain to a single utility customer. This feature is useful during process 16 to assist the person contacting a high-likelihood prospect to customize the contact according to the prospect's individual attributes.

FIG. 2 is a schematic view of an exemplary simplified power generation, transmission, and distribution system in which an embodiment may be used. It should be appreciated that the example of FIG. 2 is for an electric utility; other utilities (such as gas or water) may use other systems that fall within the scope of the invention.

Electrical power is generated by a power generation system 21. Many forms of power generation are known in the art, such as the use of heated steam to drive a steam turbine. The heat source may be, for example, nuclear fission, burning of coal, natural gas, or petroleum, solar thermal energy, and geothermal energy, among others. Other sources of power generation include hydroelectric (gravity assist), tidal power, and wind.

Once generated, power flows into a power transmission system 22. The function of power transmission is to move electrical power from the power producer to a locality of the power consumer, such as a city. Electrical power is typically transmitted as an alternating current (AC) using overhead power lines. Long distance, very high power transmission typically uses an “extra-high” line voltage of 345 kilovolts (kV), 500 kV, or 765 kV, while transmission of high power over shorter distances or to large consumers typically uses a “high” line voltage of 115 kV, 138 kV, 161 kV, or 230 kV. The power transmission system 22 receives power at the appropriate voltage from a step up electrical transformer at the power generation site that transforms the power plant output voltage to the transmission voltage.

A power distribution system 23 is used to distribute power to localities. The power distribution system 23 includes a step down transformer that transforms the high voltage AC into a “medium” voltage AC, typically between 2.4 kV and 69 kV. This medium voltage is used by power lines that distribute power, from a power station connected to the transmission system, to various industrial customers and to substations around town that are directly connected to residential customers 24, 25, and 26. Each substation includes another step down transformer that transforms the medium voltage AC into a “low” voltage AC, typically 120 volts (for use by home electrical appliances) or other voltages up to 600 volts (for use by commercial machinery).

Residential customer 26 has a solar photovoltaic (PV) system 261. This system converts solar light into electricity for use by the customer 26. The PV system 261 may include, for example, solar panels that create direct current (DC) power, and an electrical inverter that converts the DC power into AC power for use by home appliances that cannot accept DC.

If the PV system 261 is large enough, it may produce more power than can be consumed by the customer 26. In this case, the excess power can be net metered. “Net metering” is a service provided by the power utility whereby excess power generated by a customer is returned to the power distribution system 23 for use by other customers. A customer's electricity meter, which is used by the power utility to determine power usage, typically runs forward, but under net metering the electricity meter runs backward, and the customer 26 is charged only for the net amount of power drawn from the power distribution system 23. The use of the PV system 261 in this way enables distributed power generation.

In a smart electrical grid, a power utility may have a utility control center 27 that receives data from the power generation system 21, power transmission system 22, and the power distribution system 23 on a real time or near-real time basis and can act on it automatically using control commands. Reactively, a smart grid can quickly detect faults in the transmission and distribution systems (such as service interruptions, variations in line voltage, and transient voltages) and instruct local hardware to compensate. Proactively, the smart grid can control generation, transmission, and distribution as a function of actual or expected demand. For example, a typical residence draws more power when residents are home and awake, typically between 7:00 am to 8:00 am and between 6:00 pm and 10:00 pm. Many commercial operations typically draw more power during business hours. Moreover, seasonal variations may be taken into account. Thus, more power is consumed in the summer (when air conditioners are running) than in the winter.

The present invention relates to contacting energy utility customers to solicit their participation in a program to improve energy efficiency, sustainability, or reliability. In order to contact customers in a cost-effective manner, the customers' relationships with energy are profiled, and then the customers grouped according to these relationships. This is done in a customer contacting system 28 that is shown in more detail in FIG. 3. This customer contacting system 28 receives data from a utility control center 27 as indicated. It also may receive information directly from customers 24, 25, 26 as described in connection with FIG. 3. The purpose of the customer contacting system 28 is to identify which customers are likely receptive to participation in various programs that improve energy efficiency, sustainability, or reliability, and to facilitate contacting the most likely customers.

While the customer contacting system 28 is shown in FIG. 2 as being separate from the utility control center 27, in some embodiments the system 28 is co-located at the center 27. Alternately, the system 28 may be co-located at service premises of the energy utility enterprise, or at any other convenient place such as a computer hosting facility.

FIG. 3 shows more detail of a customer contacting system 28. In various embodiments, the system 28 includes at least a data exchange system 281, a data preprocessor 282, a data store 283, a clustering processor 284, a customer segment processor 285, a customer selection processor 286, and a contact processor 287. These components are now described in more detail.

It should be appreciated that each of these components may be implemented using a variety of hardware, firmware, or software. Preferred hardware and software for implementing each component in an illustrative embodiment is described below, although the scope of the invention is not limited by this example, but by the accompanying claims. In a preferred embodiment, the customer contacting system 28 is implemented using a computing system that includes hardware, firmware, and/or software that is optimized to operate on large volumes of data.

Relevant hardware may include, for example, one or more server computers interconnected using a data fabric. Each server computer may include a volatile memory, a non-volatile memory, and one or more computing microprocessors configured to execute software. Each server computer also may include a application-specific integrated circuit (ASIC), field programmable gate array (FPGA), digital signal processor (DSP), or other hardware or firmware necessary to implement the processes of FIG. 1.

In accordance with an embodiment of the invention, the data exchange system 281 collects data from customers as in process 11. The data exchange system 281 also contacts various receptive customers 24, 25, 26, as described below. The data exchange system 281 may be a conventional network adapter connected to a public data communications network 29, such as the Internet.

The data preprocessor 282 receives data from a variety of systems. Customer-descriptive data may be received from an external customer data source 32, such as a customer information system (CIS) or a customer relationship management (CRM) system. Communications-descriptive data may be received from an external CRM system. Communications-descriptive data also may be received from other external customer data sources 32 such as FACEBOOK, TWITTER, LINKEDIN, REDDIT, or other social media service, in which case the normalization and weighting processes performed by the data preprocessor 282 determine whether the data reflect positively or negatively on the energy utility, and to what extent. Usage-descriptive data may be received directly from the utility control center 27, or from smart meters attached to the customer premises. Attitude-descriptive data may be inferred from other data, or provided directly from the customer in response to a questionnaire.

The data preprocessor 282 normalizes and weights input data values as a function of business insight. The data preprocessor 282 thus has rules that convert textual data into appropriate numeric notation so that they are suitable to be processed by the grouping algorithms described below. In one embodiment, the system allows a system administrator (e.g., an employee of the utility or someone working on behalf of the utility) to change the attribute set, as well as the normalization parameters, for the purpose of grouping. This allows an administrator to customize the data model provided by the system and tune it to the requirements of the utility enterprise as they change. The data preprocessor 282 therefore may be implemented using one or more computer systems.

After preprocessing the data attributes, the data are integrated into a canonical data model that is stored in the data store 283. The data store 283 is represented in FIG. 3 as a single device, but may be implemented as a distributed data store, for example using a plurality of server computers having volatile and non-volatile memory that are executing the Apache™ Hadoop® framework. Such a distributed data store is especially advantageous for use in the present context, since utility enterprises may have many millions of customers, with correspondingly large data sets. Various improvements may be made to a default Hadoop installation to speed up calculations; for example, the default disk-based MapReduce process for executing queries may be replaced by the Apache™ Spark™ software package that can operate in memory, and the default querying interface may be replaced with the Apache™ Spark SQL module.

The data model is accessed by the clustering processor 284. The clustering processor 284 performs data clustering, as described above in connection with process 13. The clustering processor 284 may be implemented, for example, as a combination of hardware and software using the Apache™ Mahout™ scalable machine learning framework, which implements various clustering algorithms including those described above. The utility enterprise may configure the clustering processor 284 to use any particular algorithm(s) on its data set, according to relevant business rules. Thus, the clustering processor may be implemented using a plurality of server computers configured to execute distributed processes.

Once clustering has been performed, the segment processor 285 assigns customer segments to the clusters. Thus, the segment processor 285 includes data pertaining to program offerings defined by the utility enterprise independently of the customer data. These program offerings may be based on any number of factors, including regulatory incentives to the utility and its customers, utility system capabilities, program viability, and others. The segment processor 285 assigns the set of pre-defined program offerings to the data clusters. As noted above, if the clustering processor 284 identifies more clusters than programs, the utility enterprise may determine that more offerings should be developed to meet the needs of the additional clusters. The segment processor 285 may be implemented using a conventional desktop or laptop computer, or it may be implemented using the same hardware as the clustering processor 284.

The customer selection processor 286 selects the customers most likely to participate in any efficiency, reliability, or sustainability programs offered by the utility. As noted above, customer selection may be automatic based on a participation likelihood threshold, or the customers may be selected using a selection tool in a graphical user interface that displays the clustered and segmented data points. Thus, the customer selection processor 286 may be implemented using a desktop or laptop computer.

The contact processor 287 is used by the utility enterprise to facilitate contacting selected customers and to customize the contact experience. To that end, the contact processor 287 may implement a customer relationship management tool. It may also use the graphical user interface described above to select a data point representing a single customer to instruct the graphical user interface to display that customer's individual descriptive, communicative, energy usage-related, and attitudinal attributes. These attributes may be represented in the interface using different icons, and selection of the appropriate icon will display more detailed information. In this connection, an illustrative embodiment permits viewing of the segmentation and a “360 degree view” of the customer (i.e., a visual representation of the attribute information of a given user), and may include recommendations for the contact. For example, selecting a usage icon may show the monthly power use of the selected user in the 360 degree view. A utility sales employee may use these attributes during a contact with the customer, to tailor the offering to the customer's individual preferences. The contact processor 287 may be implemented together with the customer selection processor 286 using a desktop or laptop computer system, or as a standalone computing system.

Optionally, contact may be made by electronic means. Thus, the contact processor 287 may instruct the data exchange system 281 to send a message to the prospects 24, 25, 26 using the data communication network 31, for example by email, SMS, MMS, or using a smartphone app. The message may be customized as described above to suit the prospect's individual attributes and preferences.

In addition to, or instead of, exposing or making the grouping and clustering information available for visual display, these data may be integrated with other applications (e.g., third party applications). This can be done in any of a variety of manners, such as via an interface or API call. The format for data exchange is flexible, and plain text, CSV, JSON and XML formatted data can be used. Accordingly, in such embodiments, the system may forward the utility user assignment information, across some medium, to another processing device, such as an application executing on the same or a different machine. When executing, the application receiving the user assignment information may be considered to be a device or other apparatus. The medium may be a wired or wireless medium. For example, a host computing platform may forward the assignment information to the other processing device, which can be executing on a different hardware platform. The receiving application or device may process the data for any of a variety of purposes. In particular, the data may be provided to or by a middleware framework as described in U.S. patent application Ser. No. 14/666,128, filed Mar. 23, 2015.

It should be noted that logic flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

Although the above discussion discloses various exemplary embodiments of the invention, it should be apparent that those skilled in the art can make various modifications that will achieve some of the advantages of the invention without departing from the true scope of the invention.

What is claimed is:

1. A method of contacting a customer of an energy utility enterprise to solicit the customer's participation in a program to improve energy efficiency, sustainability, or reliability, the method comprising:
in a first computer process, receiving data pertaining to each customer in a plurality of utility enterprise customers, wherein the data for each customer include a plurality of attributes having values, wherein each attribute pertains to a (a) customer descriptive characteristic, (b) customer communications history with the utility enterprise, (c) customer energy usage behavior, or (d) customer attitude about energy, and wherein each value is normalized or non-normalized;
in a second computer process, populating a data model with the received data, wherein populating the data model includes transforming all non-normalized attribute values into normalized, numerical values;
in a third computer process, producing a plurality of data clusters by applying multivariate clustering to the populated data model, each data cluster including a plurality of data points, each such data point being associated with an individual utility customer;
in a fourth computer process, assigning to each cluster in the plurality of data clusters a segment in a plurality of utility customer segments, each such segment indicating, for each data point in the data cluster, either (a) a program that could improve energy efficiency, sustainability, or reliability for the associated individual utility customer, or (b) that no such program is appropriate;
in a fifth computer process, determining, for each segment indicating a program, a prospect subset of the assigned customers, the prospect subset including all customers that are most likely to participate in the indicated program according to a likelihood threshold; and
for at least one given program, contacting a customer in the prospect subset of the given segment to solicit the customer's participation in the indicated program.

2. The method according to claim 1, wherein at least one received descriptive attribute is: customer name, age, gender, location, usage category, employment status, annual income, or whether the customer uses a smart meter, a photovoltaic (PV) system, the Internet or a home area network (HAN), or an electric vehicle (EV).

3. The method according to claim 1, wherein at least one received communications attribute is: a social media identifier, a positive or negative nature of public communications about the energy utility enterprise, a preferred mode of contact, a resolution status of prior issues with the energy utility enterprise, a positive or negative nature of feedback directed to the energy utility enterprise, or a positive or negative response by the customer to a prior contact.

4. The method according to claim 1, wherein at least one received energy usage behavior attribute is: an average bill amount, an individual bill amount, an on-time or late nature of a prior bill payment, an average monthly energy demand, a maximum monthly energy demand, a maximum instantaneous energy demand, a parameter of an interconnection tariff, an amount of net metered energy, or an amount of excess energy generated by the customer that is purchased by the energy utility enterprise.

5. The method according to claim 1, wherein processing the plurality of data clusters includes applying one or more of: k-means clustering, fuzzy k-means clustering, Dirichlet clustering, hierarchical clustering, or canopy clustering.

6. The method according to claim 1, further comprising:
computing a graphical visualization of the populated data model comprising one data point for each utility customer, wherein the visualization distinctively shows the cluster into which the third computer process placed each data point;
displaying on a computer display the visualization and a selection tool that permits selection by an individual of one or more displayed data points.

7. The method according to claim 6, wherein determining the prospect subset comprises:
receiving from the selection tool a selection of a plurality of displayed data points; and
determining the prospect subset to be the customers associated with the selected data points.

9. The method according to claim 8, further comprising:
receiving from the selection tool a selection of a single displayed data point; and
displaying on the computer display a graphical view of the received attributes that pertain to the utility customer associated with the selected data point.

10. The method according to claim 1, wherein contacting the customer comprises contacting using: email, telephone, SMS, MMS, or a smartphone app.

11. The method according to claim 1, wherein contacting the customer in the prospect subset of the given program comprises customizing a parameter of the given program as a function of the plurality of attributes for the customer.

12. The method according to claim 1, further comprising creating a new utility customer segment when the plurality of data clusters produced in the third computer process outnumber the plurality of utility customer segments.

13. A system for contacting a customer of an energy utility enterprise to solicit the customer's participation in a program to improve energy efficiency, sustainability, or reliability, the system comprising:
a data store;
a data exchange system, coupled to the customer via a data communication network, the data exchange system configured to receive data pertaining to each customer in a plurality of utility enterprise customers, wherein the data for each customer include a plurality of attributes having values, wherein each attribute pertains to a (a) customer descriptive characteristic, (b) customer communications history with the utility enterprise, (c) customer energy usage behavior, or (d) customer attitude about energy, and wherein each value is normalized or non-normalized;
a data preprocessor configured to store in the data store a data model populated with the received data, wherein storing the data model includes transforming all non-normalized attribute values into normalized, numerical values;
a clustering processor configured to produce a plurality of data clusters by applying multivariate clustering to the populated data model, each data cluster including a plurality of data points, each such data point being associated with an individual utility customer;
a segment processor configured to assign to each cluster in the plurality of data clusters a segment in a plurality of utility customer segments, each such segment indicating, for each data point in the data cluster, either (a) a program that could improve energy efficiency, sustainability, or reliability for the associated individual utility customer, or (b) that no such program is appropriate;
a customer selection processor configured to determine, for each segment indicating a program, a prospect subset of the assigned customers, the prospect subset including all customers that are most likely to participate in the indicated program according to a likelihood threshold; and
a contact processor configured to contact a customer in the prospect subset for at least one given program, to solicit the customer's participation in the indicated program.

13. The system according to claim 12, wherein the clustering processor is further configured to apply one or more of: k-means clustering, fuzzy k-means clustering, Dirichlet clustering, hierarchical clustering, or canopy clustering.

14. The system according to claim 12, wherein the customer selection processor further comprises:
a computer display, the computer display displaying (a) a graphical visualization of the populated data model comprising one data point for each utility customer, wherein the visualization distinctively shows the cluster into which the third computer process placed each data point, and (b) a selection tool that permits selection by an individual of one or more displayed data points.

15. The system according to claim 14, wherein the customer selection processor is further configured to:
receive from the selection tool a selection of a plurality of displayed data points; and
determine the prospect subset to be the customers associated with the selected data points.

16. The system according to claim 15, wherein the customer selection processor and the contact processor comprise a single device, and wherein the contact processor is further configured to:
receive from the selection tool a selection of a single displayed data point; and
display on the computer display a graphical view of the received attributes that pertain to the utility customer associated with the selected data point.

17. The system according to claim 12, wherein the contact processor is further configured to contact the customer using: email, telephone, SMS, MMS, or a smartphone app.

18. The system according to claim 12, wherein contacting the customer in the prospect subset of the given program comprises the contact processor customizing a parameter of the given program as a function of the plurality of attributes for the customer.

19. A method comprising:
receiving utility user information relating to a plurality of utility users, the utility user information including normalized user information, non-normalized utility information, or both normalized user information and non-normalized utility information, the utility user information of each of a set of utility users having a plurality of different attributes relating to the user;
transforming non-normalized utility user information into normalized utility user information if the received utility user information includes non-normalized utility information, transforming comprising converting non-numerical utility user information to a numerical value;
providing a plurality of user segments;
applying at least one segmenting technique to the utility user information, the segmenting technique comprising a clustering technique;
assigning, by a host computing platform, each of the utility users to one or more user segments to produce user assignment information, assigning being executed by applying the clustering technique to the utility user information;
populating a plurality of user records with the utility user assignment information;
storing the plurality of records in a clustered database;
a database management system retrieving utility user assignment information from the user records in the clustered database; and
transforming, at the host computing platform, the utility user assignment information into graphical indicia to produce output graphical indicia information relating to the user segments and the utility user information.

20. The method of claim 19, further comprising forwarding the utility user assignment information to another processing device.
